(19) United States
(12) Patent Application Publication
(10) Pub. No.: US 2021/0318949 A1
(43) Pub. Date: Oct. 14, 2021

(54) METHOD FOR CHECKING FILE DATA, COMPUTER DEVICE AND READABLE STORAGE MEDIUM

(71) Applicants: Fu Tai Hua Industry (Shenzhen) Co., Ltd., Shenzhen (CN); HON HAI PRECISION INDUSTRY CO., LTD., New Taipei (TW)

(72) Inventors: DING-HUANG LIN, New Taipei (TW); CHING-HSUAN CHEN, New Taipei (TW); AN-CHI HUANG, New Taipei (TW)

(21) Appl. No.: 16/858,962

(22) Filed: Apr. 27, 2020

(30) Foreign Application Priority Data
Apr. 10, 2020 (CN) 202010279395.9

(51) Int. Cl. G06F 11/36; G06K 9/62; G06N 3/04

(52) U.S. Cl. CPC G06F 11/3688; G06F 11/3692; G06N 3/04; G06K 9/6256; G06F 11/3684

(57) ABSTRACT

A method of checking file data is provided. The method includes obtaining text information of a test file. The text information of the test file is converted into vectors, thus vectors corresponding to the test file are obtained. A quality category of the test file is obtained based on the vectors corresponding to the test file. Once the test file is determined not to meet a requirement according to the quality category of the test file, a template file corresponding to the test file is provided.

### FIELD

The present disclosure relates to data processing technology, in particular to a method for checking file data, a computer device, and a readable storage medium.

### BACKGROUND

In the industrial production field, a user can manually record defects of defective products or errors in a production process in a file. However, errors may be occurred in the file based on the manual operations. Therefore, it is needed to improve.

### BRIEF DESCRIPTION OF THE DRAWINGS

FIG. 1 illustrates a schematic diagram of a computer device according to one embodiment of the present disclosure.

FIG. 2 shows one embodiment of modules of a checking system of the present disclosure.

FIG. 3 shows a flow chart of one embodiment of a method of checking file data of the present disclosure.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

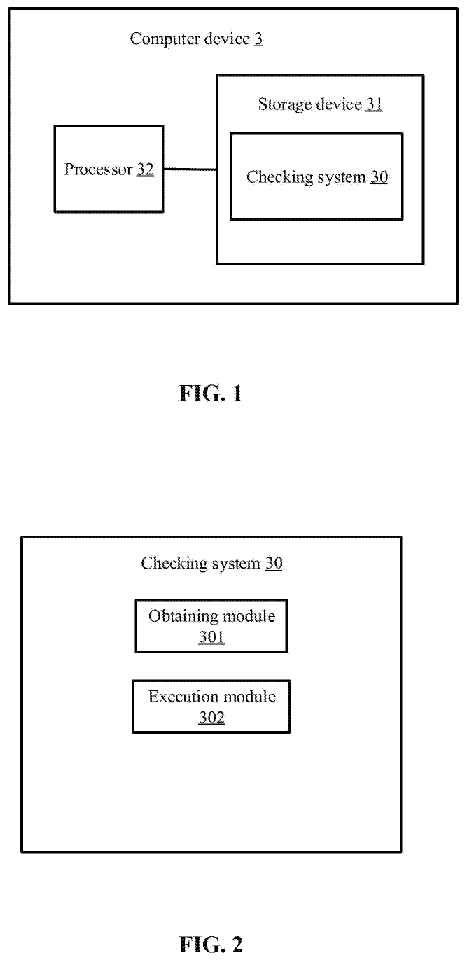

FIG. 1 illustrates a schematic diagram of a computer device 3 of the present disclosure.

In at least one embodiment, the computer device 3 includes a storage device 31, and at least one processor 32. These elements are electronically connected with each other.

Those skilled in the art should understand that the structure of the computer device 3 shown in FIG. 1 does not constitute a limitation of the embodiment of the present disclosure. The computer device 3 may further include more or less other hardware or software than that shown in FIG. 1, or the computer device 3 may have different component arrangements.

It should be noted that the computer device 3 is merely an example. If another kind of computer devices can be adapted to the present disclosure, it should also be included in the protection scope of the present disclosure, and incorporated herein by reference

In some embodiments, the storage device 31 may be used to store program codes and various data of computer programs. For example, the storage device 31 may be used to store a checking system 30 installed in the computer device 3, and implement completion of storing programs or data during an operation of the computer device 3. The storage device 31 may include Read-Only Memory (ROM), Programmable Read-Only Memory (PROM), Erasable Programmable Read-Only Memory (EPROM), One-time Programmable Read-Only Memory (OTPROM), Electronically-Erasable Programmable Read-Only Memory (EEPROM), Compact Disc (Compact Disc) Read-Only Memory (CD-ROM) or other optical disk storage, disk storage, magnetic tape storage, or any other non-transitory computer-readable storage medium that can be used to carry or store data.

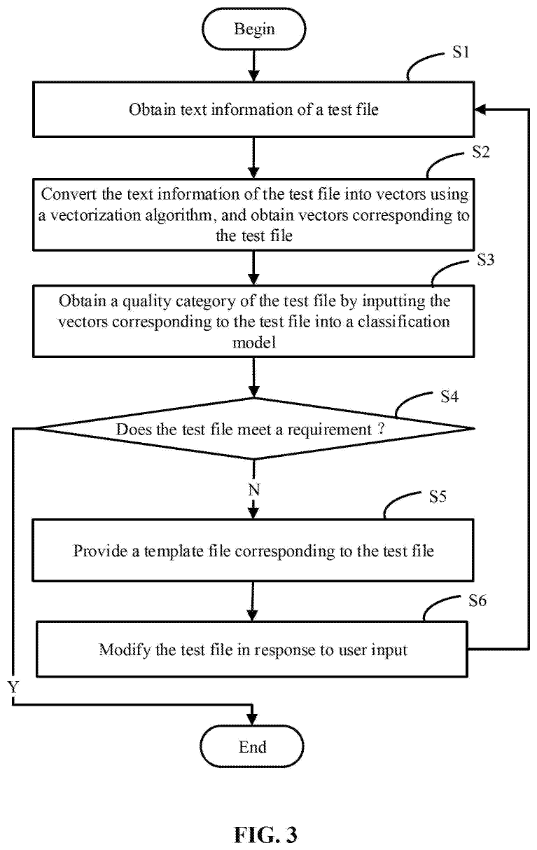

In some embodiments, the at least one processor 32 may be composed of an integrated circuit. For example, the at least one processor 32 can be composed of a single packaged integrated circuit, or multiple packaged integrated circuits with same function or different function. The at least one processor 32 includes one or more central processing units (CPUs), one or more microprocessors, one or more digital processing chips, one or more graphics processors, and various control chips. The at least one processor 32 is a control unit of the computer device 3. The at least one processor 32 uses various interfaces and lines to connect various components of the computer device 3, executes programs or modules or instructions stored in the storage device 31, and invokes data stored in the storage device 31 to perform various functions of the computer device 3 and process data, for example, perform a function of checking file data (for details, see the description of FIG. 3).

In this embodiment, the checking system 30 may include one or more modules. The one or more modules are stored in the storage device 31, and executed by at least one processor (e.g. the processor 32 in this embodiment), such that a function of checking file data (for details, see the introduction to FIG. 3 below) is achieved.

In this embodiment, the checking system 30 may include a plurality of modules. Referring to FIG. 2, the plurality of modules includes an obtaining module 301, and an execution module 302. The module in the present disclosure refers to a series of computer-readable instructions that can be executed by at least one processor (for example, the processor 32), and can complete functions, and can be stored in a storage device (for example, the storage device 31 of the computer device 3). In this embodiment, functions of each module will be described in detail with reference to FIG. 3.

In this embodiment, an integrated unit implemented in a form of a software module can be stored in a non-transitory readable storage medium. The above modules include one or more computer-readable instructions. The computer device 3 or a processor implements the one or more computer-readable instructions, such that a method for checking file data shown in FIG. 3 is achieved.

In a further embodiment, referring to FIG. 2, the at least one processor 32 can execute an operating system of the computer device 3, various types of applications (such as the checking system 30 described above), program codes, and the like.

In a further embodiment, the storage device 31 stores program codes of a computer program, and the at least one processor 32 can invoke the program codes stored in the storage device 31 to achieve related functions. For example, each of the modules of the checking system 30 shown in FIG. 2 is a program code stored in the storage device 31. Each of the modules of the checking system 30 shown in FIG. 2 is executed by the at least one processor 32, such that the functions of the modules are achieved, and a purpose of checking file data (see the description of FIG. 3 below for details) is achieved.

In one embodiment of the present disclosure, the storage device 31 stores one or more computer-readable instructions, and the one or more computer-readable instructions are executed by the at least one processor 32 to achieve a purpose of checking file data. Specifically, the computer-readable instructions executed by the at least one processor 32 to achieve the purpose of checking file data is described in detail in FIG. 3 below.

FIG. 3 is a flowchart of a method of checking file data according to a preferred embodiment of the present disclosure.

In this embodiment, the method of checking file data can be applied to the computer device 3. For the computer device 3 that requires to checking file data, the computer device 3 can be directly integrated with the function of checking file data. The computer device 3 can also achieve the function of checking file data by running a Software Development Kit (SDK).

Referring to FIG. 3, the method is provided by way of example, as there are a variety of ways to carry out the method. The method described below can be carried out using the configurations illustrated in FIG. 1, for example, and various elements of these figures are referenced in explanation of method. Each block shown in FIG. 3 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The example method can begin at block S1.

At block S1, the obtaining module 301 obtains text information of a file that is to be checked. To clearly describe the present disclosure, hereinafter “the file that is to be checked” is referred to as “test file”.

In this embodiment, the test file may record various information such as a name of a product, a date of manufacture, and other information.

In this embodiment, a file format of the test file can be any type such as “.xls”, “.doc”, or other format such as “.docx”.

In this embodiment, the test file includes a plurality of areas. In one embodiment, each of the plurality of areas can correspond to a cell on one page of the test file. Each of the plurality of areas can be used to record different information. For example, a first area of the plurality of areas is used to record a name of a product, and a second area of the plurality of areas is used to record a serial number of the product. That is, the text information obtained by the obtaining module 301 from the first area is the name of the product. The text information obtained from the second area is the serial number of the product.

In one embodiment, the obtaining of the text information of the test file includes:

obtaining the text information corresponding to each of the plurality of areas of the test file according to a preset order;

processing the text information corresponding to each of the plurality of areas, such that processed text information is obtained, and setting the processed text information as the text information of the test file.

In one embodiment, the preset order may be an order of top to bottom first and then from left to right. For example, the obtaining module 301 can first obtain the text information from a third area that is located in a top left of one page of the test file, and then obtain the text information from a fourth area that is located to the right of the third area on the same page of the test file, the third area and the fourth area are being in same row on the one page of the test file. In other embodiments, the preset order may be other kind of orders.

In one embodiment, the processing of the text information corresponding to each of the plurality of areas includes:

recording the text information corresponding to each area of the plurality of areas according to an obtaining order of obtaining the text information corresponding to the each area; and unifying a format of all text information, i.e., formatting all text information into one consistent format.

In one embodiment, previously obtained text information is recorded above next obtained text information.

In one embodiment, the unifying the format of all text information may include, but is not limited to, removing punctuation marks such as periods from all text information, removing log records (Log) from all text information in response to user input, unifying a format of each English letter of all text information (for example, rewriting all uppercase English letters to lowercase English letters), unifying a font format of all text information (for example, changing the font format of each Chinese word of all text information to be “Song Ti”, and changing the font format of each English letter of all text information to be “Times New Roman”), and/or uniform a tense, a singular style or a plural style of English words of all text information.

In one embodiment, the obtaining module 301 may further establish a relationship between each area and the text information corresponding to each area.

At block S2, the execution module 302 converts the text information of the test file into vectors using a vectorization algorithm, such that the vectors corresponding to the test file are obtained.

In one embodiment, the vectorization algorithm can be a TF-IDF (term frequency-inverse document frequency) algorithm.

It should be noted that the TF-IDF algorithm is a statistical method for evaluating an importance of a word relative to a document or an importance of one document in a corpus. The importance of the word increases proportionally with the number of times the word appears in the document, but at the same time it decreases inversely with a frequency of the word's appearance in the corpus.

In other embodiments, the vectorization algorithm can be a Word2Vec algorithm.

It should be noted that the Word2Vec algorithm considers a relationship between a context of a word in a document and the word. The Word2Vec algorithm is a two-layer neural network. The Word2Vec algorithm can be used to map each word to a vector, which can be used to express the relationship word-to-word.

In this embodiment, the Word2Vec algorithm may be a CBOW model (Continuous Bag of Words Model) or a Skip-gram model (Continuous Skip-gram Model). Among them, the CBOW model is a network that predicts a current word on a premise of the context; the Skip-gram model is a network that predicts the context on a premise of the current word. Since the Word2Vec algorithm considers the relationship between the current word and the context, the vector of any two words generated by the Word2Vec algorithm is a similarity between the two words. That is, the vector of any two words can express the meanings of the two words. In comparison, the vectors generated by the TF-IDF algorithm is an expression of a word frequency. Therefore, compared to the vectors generated by the TF-IDF algorithm, the vectors generated by the Word2Vec algorithm is more representative of features of the test file in the corpus because it contains semantic components.

At block S3, the execution module 302 obtains a quality category of the test file by inputting the vectors corresponding to the test file into a classification model.

In one embodiment, the quality category may be categorized into an excellent category, a medium category, and a poor category. Different categories represent different differences in quality. In this embodiment, the excellent category represents the best quality, and the poor category represents a lowest quality, and the medium category represents a middling quality which is better than the poor category but lower than the excellent category.

In one embodiment, the execution module 302 can perform a preliminary classification on the quality category of the test file before inputting the vectors corresponding to the test file into the classification model, the classification model outputs the quality category of the test file based on the vectors corresponding to the test file.

Specifically, the performing of the preliminary classification on the quality category of the test file includes:

determining whether the test file meets a specified condition according to the text information of the test file;

determining that the quality category of the test file is the poor category when the test file meets the specified condition. In other words, when the test file meets the specified condition, the execution module 302 can directly determine the test file does not meet a requirement.

In one embodiment, the execution module 302 inputs the vectors corresponding to the test file to the classification model when the test file does not meet the specified condition.

In one embodiment, the test file meeting the specified condition represents that the test file lacks text information in a specific area of the test file, and/or that the specific area includes repeated text.

In one embodiment, the specific area can be any one area of the plurality of areas of the test file.

In one embodiment, the execution module 302 can pre-process the vectors corresponding to the test file before inputting the vectors corresponding to the test file into the classification model, and obtain pre-processed vectors. The execution module 302 can input the pre-processed vectors into the classification model to obtain the quality category of the test file.

Specifically, the pre-processing of the vectors corresponding to the test file includes extracting keywords from the vectors corresponding to the test file, such that extracted keywords are obtained; and categorizing the extracted keywords.

In one embodiment, the categorizing of the extracted keywords includes unifying different names corresponding to one target into a same name; and/or categorizing proper nouns into a same category, words representing actions into a same category, conjunctions into a same category, similar words into a same category, and synonyms into a same category.

In one embodiment, the execution module 302 obtains the classification model by training a neural network.

Specifically, the obtaining of the classification model by training the neural network includes (a1)-(a3).

(a1) the execution module 302 collects a preset number (for example, 100,000 copies) of sample data, and each sample data of the preset number of sample data includes text information of a file (to clearly describe the present disclosure, hereinafter “the file” is referred to as “sample file”).

(a2) the execution module 302 processes each sample data and obtains the preset number of processed sample data.

In this embodiment, the processing of each sample data includes vectorizing the text information of each sample file using the vectorization algorithm, thereby vectors corresponding to each sample file are obtained; and marking a quality category of each sample file.

Specifically, the execution module 302 can mark the quality category of each sample file in response to user input. In other words, whether the quality category of the sample file is the excellent category, the medium category, or the poor category is marked in response to user input.

In an embodiment, the processing of each sample data further includes:

extracting keywords from the vectors corresponding to each sample file; and classifying the extracted keywords.

In one embodiment, the classifying of the extracted keywords includes, but is not limited to, unifying different names corresponding to a same target into a same name; and/or categorizing proper nouns into a same category, words representing actions into one category, conjunctions into one category, similar words into one category, and synonyms into one category.

(a3) the execution module 302 obtains the classification model by training a neural network (for example, LSTM (Long Short Term Memory networks)) using the preset number of processed sample data.

At block S4, the execution module 302 determines whether the test file meets the requirement according to the quality category of the test file. When the test file meets the requirement, the process goes to block S5. When the test file does not meet the requirement, the execution module 302 can prompt the user of a test result of the test file, and the process is end.

In one embodiment, when the quality category of the test file is the poor category, the execution module 302 determines that the test file does not meet the requirement. When the quality category of the test file is the medium category or the excellent category, the execution module 302 determines that the test file meets the requirement.

At block S5, when the test file does not meet the requirement, the execution module 302 provides a template file corresponding to the test file for reference. Thus, the user can modify the test file according to the template file.

In one embodiment, the providing of the template file corresponding to the test file includes (b1)-(b4).

(b1) the execution module 302 obtains text information corresponding to each template file of a plurality of template files. The text information corresponding to each template file is pre-stored in the storage device 31 by the execution module 302.

In one embodiment, the quality category of each template file is the excellent category. In one embodiment, the plurality of template files can be the sample files that are marked with the excellent category among the preset number of sample files. Of course, the plurality of template files may be collected in other way.

(b2) the execution module 302 calculates a similarity value between the text information of the test file and the text information corresponding to each of the plurality of template files, thereby a plurality of similarity values is obtained.

(b3) the execution module 302 associates each of the plurality of similarity values with each template file.

For example, two similarity values, e.g., V1 and V2 are obtained. V1 represents a similarity value between the text information of the test file and the text information corresponding to a template file “T1”; V2 represents a similarity value between the text information of the test file and the text information corresponding to a template file “T2”. Then the execution module 302 associates the similarity value V1 with the template file “T1”; and associates the similarity value V2 with the template file “T2”.

(b4) the execution module 302 determines the template file corresponding to the test file according to the plurality of similarity values, and displays the template file corresponding to the test file on a display device (not shown in FIG. 1) of the computer device 3, such that the user can use the template file as a reference to modify the test file.

In one embodiment, the similarity value corresponding to the displayed template file is a maximum value among the plurality of similarity values.

In other embodiments, block S6 may be further included after block S5.

At block S6, the execution module 302 modifies the test file in response to user input. When the block S6 is executed, the process returns to block S1. Such that, the quality category of the test file can be re-checked after the test file is modified in response to user input.

The above description is only embodiments of the present disclosure, and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A method for checking file data applied to a computer device, the method comprising:
obtaining text information of a test file;
converting the text information of the test file into vectors using a vectorization algorithm, and obtaining the vectors corresponding to the test file;
obtaining a quality category of the test file by inputting the vectors corresponding to the test file into a classification model;
determining whether the test file meets a requirement according to the quality category of the test file; and
providing a template file corresponding to the test file when the test file does not meet the requirement.

2. The method according to claim 1, further comprising:
modifying the test file in response to user input; and
returning to the obtaining of the text information of the test file.

3. The method according to claim 1, wherein the providing the template file corresponding to the test file comprises:
obtaining text information corresponding to each template file of a plurality of template files;
calculating a similarity value between the text information of the test file and the text information corresponding to each template file, and obtaining a plurality of similarity values;
associating each of the plurality of similarity values with each template file;
determining the template file corresponding to the test file according to the plurality of similarity values; and
displaying the template file corresponding to the test file.

4. The method according to claim 3, wherein the similarity value corresponding to the displayed template file is a maximum value among the plurality of similarity values.

5. The method according to claim 1, further comprising:
obtaining the classification model by training a neural network;
wherein the training of the neural network comprises:
collecting a preset number of sample data, each sample data of the preset number of sample data comprising text information of a sample file;
processing each sample data and obtaining the preset number of processed sample data, wherein the processing each sample data comprises: vectorizing the text information of each sample file using the vectorization algorithm and obtaining vectors corresponding to each sample file; and marking a quality category of each sample file; and
obtaining the classification model by training the neural network using the preset number of processed sample data.

6. The method according to claim 1, further comprising:
determining whether the test file meets a specified condition according to the text information of the test file, before inputting the vectors corresponding to the test file into the classification model;
determining that the test file does not meet the requirement when the test file meets the specified condition; and
triggering the inputting the vectors corresponding to the test file into the classification model when the test file does not meet the specified condition.

7. The method according to claim 6, wherein the test file meeting the specified condition represents that the test file misses text information in an area of the test file, and/or the area comprises repeated text.

8. A computer device comprising:
a storage device; and
at least one processor;
wherein the storage device stores one or more programs, which when executed by the at least one processor, cause the at least one processor to:
obtain text information of a test file;
convert the text information of the test file into vectors using a vectorization algorithm, and obtain the vectors corresponding to the test file;
obtain a quality category of the test file by inputting the vectors corresponding to the test file into a classification model;
determine whether the test file meets a requirement according to the quality category of the test file; and
provide a template file corresponding to the test file when the test file does not meet the requirement.

9. The computer device according to claim 8, wherein the at least one processor is further caused to:
modify the test file in response to user input; and
return to the obtaining of the text information of the test file.

10. The computer device according to claim 8, wherein the providing the template file corresponding to the test file comprises:
obtaining text information corresponding to each template file of a plurality of template files;
calculating a similarity value between the text information of the test file and the text information corresponding to each template file, and obtaining a plurality of similarity values;
associating each of the plurality of similarity values with each template file;
determining the template file corresponding to the test file according to the plurality of similarity values; and
displaying the template file corresponding to the test file.

11. The computer device according to claim 10, wherein the similarity value corresponding to the displayed template file is a maximum value among the plurality of similarity values.

12. The computer device according to claim 8, wherein the at least one processor is further caused to:
obtain the classification model by training a neural network;
wherein the training of the neural network comprises:
collecting a preset number of sample data, each sample data of the preset number of sample data comprising text information of a sample file;
processing each sample data and obtaining the preset number of processed sample data, wherein the processing each sample data comprises: vectorizing the text information of each sample file using the vectorization algorithm and obtaining vectors corresponding to each sample file; and marking a quality category of each sample file; and
obtaining the classification model by training the neural network using the preset number of processed sample data.

13. The computer device according to claim 8, wherein the at least one processor is further caused to:
determine whether the test file meets a specified condition according to the text information of the test file, before inputting the vectors corresponding to the test file into the classification model;
determine that the test file does not meet the requirement when the test file meets the specified condition; and
trigger the inputting the vectors corresponding to the test file into the classification model when the test file does not meet the specified condition.

14. The computer device according to claim 13, wherein the test file meeting the specified condition represents that the test file misses text information in an area of the test file, and/or the area comprises repeated text.

15. A non-transitory storage medium having instructions stored thereon, when the instructions are executed by a processor of a computer device, the processor is configured to perform a method of checking file data, wherein the method comprises:
obtaining text information of a test file;
converting the text information of the test file into vectors using a vectorization algorithm, and obtaining the vectors corresponding to the test file;
obtaining a quality category of the test file by inputting the vectors corresponding to the test file into a classification model;
determining whether the test file meets a requirement according to the quality category of the test file; and
providing a template file corresponding to the test file when the test file does not meet the requirement.

16. The non-transitory storage medium according to claim 15, wherein the method further comprises:
modifying the test file in response to user input; and
returning to the obtaining of the text information of the test file.

17. The non-transitory storage medium according to claim 15, wherein the providing the template file corresponding to the test file comprises:
obtaining text information corresponding to each template file of a plurality of template files;
calculating a similarity value between the text information of the test file and the text information corresponding to each template file, and obtaining a plurality of similarity values;
associating each of the plurality of similarity values with each template file;
determining the template file corresponding to the test file according to the plurality of similarity values; and
displaying the template file corresponding to the test file.

18. The non-transitory storage medium according to claim 17, wherein the similarity value corresponding to the displayed template file is a maximum value among the plurality of similarity values.

19. The non-transitory storage medium according to claim 15, wherein the method further comprises:
obtaining the classification model by training a neural network;
wherein the training of the neural network comprises:
collecting a preset number of sample data, each sample data of the preset number of sample data comprising text information of a sample file;
processing each sample data and obtaining the preset number of processed sample data, wherein the processing each sample data comprises: vectorizing the text information of each sample file using the vectorization algorithm and obtaining vectors corresponding to each sample file; and marking a quality category of each sample file; and
obtaining the classification model by training the neural network using the preset number of processed sample data.

20. The non-transitory storage medium according to claim 15, wherein the method further comprises:
determining whether the test file meets a specified condition according to the text information of the test file, before inputting the vectors corresponding to the test file into the classification model;
determining that the test file does not meet the requirement when the test file meets the specified condition; and
triggering the inputting the vectors corresponding to the test file into the classification model when the test file does not meet the specified condition.
